(19) United States
(12) Patent Application Publication
(10) Pub. No.: US 2024/0337364 A1
(43) Pub. Date: Oct. 10, 2024

(54) Annular Lamp Assembly and Operation Box

(71) Applicant: LIXIL Living Technology (Suzhou) Corporation, Suzhou, Jiangsu (CN)

(72) Inventors: Peihua Yan, Suzhou (CN); Jing Zhu, Suzhou (CN); Dai Goto, Suzhou (CN)

(73) Assignee: LIXIL Living Technology (Suzhou) Corporation, Suzhou, JS (CN)

(21) Appl. No.: 18/579,068

(22) PCT Filed: Jul. 13, 2022
(86) PCT No.: PCT/CN2022/105409

§ 371 Date: Jan. 12, 2024

(30) Foreign Application Priority Data
Jul. 15, 2021 (CN) 202121607379.4

(51) Int. Cl. F21V 3/02; F21V 9/40; F21V 23/00; F21V 23/04; F21V 33/00; F21Y 115/10

(52) U.S. Cl. CPC F21V 3/02; F21V 9/40; F21V 23/005; F21V 23/04; F21V 33/004; F21Y 2115/10

(57) ABSTRACT

An annular lamp assembly (100) and an operation box (1), the annular lamp assembly (100) comprising: a circuit board (101); a lampshade (200), which comprises an outer annular wall (210) and an inner annular wall (220) separately provided on the circuit board (101), and an annular band area (201) being formed between the outer annular wall (210) and the inner annular wall (220); a plurality of LED lamp beads (300), which are located on the circuit board (101) of the annular hand area (201) and are arranged at intervals along the annular hand area (201); and a button (400), which is provided in a space formed by the enclosing of the inner annular wall (220), and the button (400) being suitable for turning the LED lamp beads (300) on or off. The annular lamp assembly (100) can have the effect of defining a light-receiving area in a specific space on light emitted from the LED lamp beads (300), thereby reducing light leakage.

The application claims priority to Chinese Patent Application No. 202121607379.4 filed with the China National Intellectual Property Administration on Jul. 15, 2021 and entitled “Annular Lamp Assembly and Operation Box,” the contents of which are incorporated herein by reference in their entirety.

### TECHNICAL FIELD

The present invention relates to the technical field of manufacture of toilets, and in particular to an annular lamp assembly and an operation box.

### BACKGROUND ART

Toilets are one kind of indispensable bathroom wares in modem society. With the development of the toilet manufacturing industry, people have higher and higher requirements for the integration and functionality of toilets, and toilets are becoming more and more intelligent in use.

Smart toilets can support functions such as butt cleaning, female cleaning, warm air drying, or toilet flushing. In order to facilitate users to choose operating modes according to their needs, an operation box is usually equipped on one side of a toilet cover of a smart toilet. A plurality of lamp assemblies on the operation box correspond to various functions for users to choose and use. Here, the lamp assemblies comprise buttons and corresponding display lamps. Upon a certain button being pressed by a user, the display lamp corresponding to the button lights up, and a corresponding function is activated. Upon the button being pressed by the user again after use, the button display lamp goes out, prompting the end of the operation.

The structure of the lamp assembly of an existing smart toilet still needs to be improved.

### SUMMARY OF THE INVENTION

The problem to be solved by the present invention is to provide an annular lamp assembly and an operation box, which can define a light-receiving area in a specific space and improve a user's sensory experience.

In order to solve the above-mentioned problem, the present invention provides an annular lamp assembly, comprising: a circuit board; a lampshade comprising an outer annular wall and an inner annular wall separately provided on the circuit board, and an annular band area being formed between the outer annular wall and the inner annular wall; a plurality of LED lamp beads located on the circuit board of the annular band area and arranged at intervals along the annular band area; and a button provided in a space formed by the enclosing of the inner annular wall, and the button being suitable for turning the LED lamp beads on or off.

Optionally, the LED lamp beads are arranged at equal intervals, and scattering regions of light emitted from adjacent LED lamp beads partially overlap.

Optionally, the annular lamp assembly further comprises: separating ridges, wherein a plurality of separating ridges is included between the inner annular wall and the outer annular wall, the separating ridges fixedly connect the outer annular wall and the inner annular wall, and the separating ridges are arranged at intervals.

Optionally, a single LED lamp bead is located between two adjacent separating ridges.

Optionally, the circuit board is provided with a plurality of first adhesive filling holes suitable for filling a space between two adjacent separating ridges with an adhesive.

Optionally, the annular lamp assembly further comprises: a first adhesive for filling the space between two adjacent separating ridges.

Optionally, the annular lamp assembly further comprises: a plurality of connecting bars connecting the inner annular wall and the button.

Optionally, the connecting bar comprises a first connecting section and a second connecting section perpendicular to each other, wherein the connecting bars are arranged around the button in a counterclockwise or clockwise direction.

Optionally, the lampshade and the button are integrally formed.

Optionally, the circuit board is provided with a plurality of second adhesive filling holes suitable for filling a space formed by the enclosing of the inner annular wall with an adhesive.

Optionally, the annular lamp assembly further comprises: a second adhesive for filling the space formed by the enclosing of the inner annular wall,

Optionally, a button switch is provided in the circuit board below the button, wherein the button switch is electrically connected to the LED lamp beads, and the button is suitable for pressing the button switch to turn the LED lamp beads on or off.

Optionally, the annular lamp assembly further comprises: a functional unit, wherein the button switch is electrically connected to the functional unit, and the button is also suitable for pressing the button switch to turn the functional unit on or off, and wherein the LED lamp beads are turned on when the functional unit is turned on, and the LET) lamp beads are turned off when the functional unit is turned off.

The present invention further provides an operation box, comprising: a box body having an opening at the top; and an annular lamp assembly located in the box body, wherein the opening exposes the annular lamp assembly.

Optionally, the operation box further comprises: a surface sticker pasted on the opening.

Optionally, the surface sticker comprises: a light-shielding layer comprising a light-transmitting area and a light-shielding area, the light-transmitting area being annular, and the light-transmitting area being aligned with the annular band area; and a surface sticker top layer covering the top of the light-shielding layer, light emitted from the LED lamp beads being transmitted through the light-transmitting area and the surface sticker top layer.

Compared with the prior art, the technical solution of the present invention has the following advantages:

The annular lamp assembly comprises: a circuit board, a lampshade, a plurality of LED lamp beads and a button. The lampshade comprises an outer annular wall and an inner annular wall separately provided on the circuit board, and an annular band area is formed between the outer annular wall and the inner annular wall. The plurality of LED lamp beads is located on the circuit board of the annular band area and is arranged at intervals along the annular band area. The light emitted from the LED lamp beads is defined to exit from the annular band area under the light condensing effect of the outer annular wall and the inner annular wall, thereby forming a concentrated and clear annular light, which defines a light-receiving area in a specific space, thereby helping to enhance a user's sensory experience.

### BRIEF DESCRIPTION OF THE DRAWINGS

FIG. 1 is a schematic view of the structure of an annular lamp assembly according to an embodiment of the present invention;

FIG. 2 is a longitudinal cross-sectional view of the annular lamp assembly shown in FIG. 1;

FIG. 3 is a perspective view of an operation box according to an embodiment of the present invention;

FIG. 4 is a top view of the operation box, shown in FIG. 3;

FIG. 5 is a front view of the operation box shown in FIG. 3;

FIG. 6 is a perspective view of an operation box and a mounting base according to an embodiment of the present invention;

FIG. 7 is a top view of the operation box and the mounting base shown in FIG. 6;

FIG. 8 is a longitudinal cross-sectional view of a surface sticker according to an embodiment of the present invention; and

FIG. 9 is an enlarged view of an area A shown in FIG. 7.

### DETAILED DESCRIPTION OF EMBODIMENTS

Now, it's analyzed in conjunction with a lamp assembly of a smart toilet that a lampshade of the lamp assembly is composed of an inner lampshade and an outer lampshade separately provided on a circuit board, wherein projections of the inner lampshade and the outer lampshade towards the circuit board are both in the shape of arc segments. An arc-shaped band area is formed by the enclosing of the inner lampshade and the outer lampshade. LED lamp beads of the lamp assembly are located on the arc-shaped band area. The two ends of the arc-shaped band area are open, which is prone to result in light leakage, thereby causing the divergence of light. The light condensing effect of the lampshade is poor, affecting a user's sensory experience.

The inventors have studied the above-mentioned problems. With creative efforts, the inventors have noticed that by providing a lampshade comprising an outer annular wall and an inner annular wall, the effect of defining a light-receiving area in a specific space on light emitted from the LED lamp beads can be achieved, thereby enhancing a user's sensory experience.

In order to make the above-mentioned objects, features, and advantages of the present invention clearer and more understandable, specific embodiments of the present invention will be described in detail below with reference to the accompanying drawings.

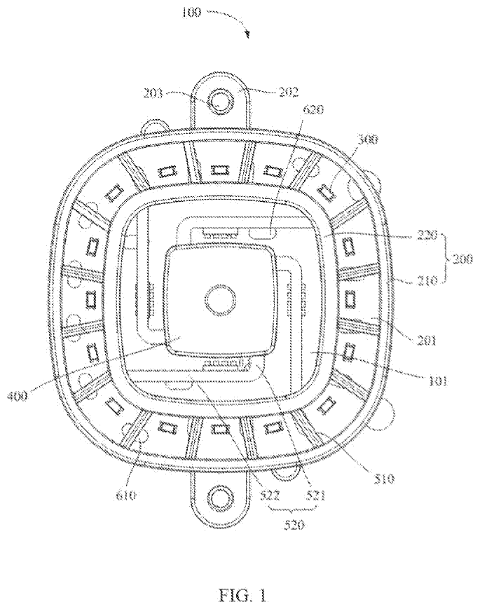

FIG. 1 is a schematic view of the structure of an annular lamp assembly 100 according to an embodiment of the present invention.

Referring to FIG. 1, an annular lamp assembly 100 comprises: a circuit board 101, a lampshade 200, a plurality of LED lamp beads 300, and a button 400. The lampshade 200 comprises an outer annular wall 210 and an inner annular wall 220 separately provided on the circuit board 101, and an annular band area 201 is formed between the outer annular wall 210 and the inner annular wall 220. The plurality of LED lamp beads 300 is located on the circuit board 101 of the annular band area 201 and is arranged at intervals along the annular band area 201. The button 400 is provided in a space formed by the enclosing of the inner annular wall 220, and the button 400 is suitable for turning the LED lamp beads 300 on or off.

The tops of the outer annular wall 210 and the inner annular wall 220 are both higher than the LED lamp beads 300, and a closed annular band area 201 is formed by the enclosing along the circumferential direction of the outer annular wall 210 and the inner annular wall 220, and thus, light emitted from the LED lamp beads 300 is defined to only be able to exit to a position over the annular band area 201. Therefore, the outer annular wall 210 and the inner annular wall 220 can have the effect of defining a light-receiving area in a specific space on the light emitted from the LED lamp beads 300, thereby forming a concentrated and clear annular light, and helping to improve a user's sensory experience.

The annular light-formed by the LED lamp beads 300 surrounds the button 400, intuitively showing the corresponding relationship between the light and the button 400, and better prompting the user to operate the button 400 for using the corresponding function.

In this embodiment, the LED lamp beads 300 are arranged at equal intervals, and the scattering regions of the light emitted from the adjacent LED lamp beads 300 partially overlap, thereby ensuring that the light emitted from the plurality of LED lamp beads 300 as a whole is annular, and improving the uniformity of light intensity of all parts of the annular light to ensure the consistent light intensity of all the parts.

A projection of the outer annular wall 210 towards the circuit board 101 is in a circular, elliptical, or polygonal shape. Among them, the polygonal shape includes a polygonal shape with vertex angles and a polygonal shape with rounded corners.

A projection of the inner annular wall 220 towards the circuit board 101 is in a circular, elliptical, or polygonal shape. Among them, the polygonal shape includes a polygonal shape with vertex angles and a polygonal shape with rounded corners.

In this embodiment, the outer annular wall 210 and the inner annular wall 220 are arranged in a spaced manner, and the button 400 is connected to the inner annular wall 220 to help determine the relative positions of the outer annular wall 210, the inner annular wall 220, and the button 400 to facilitate assembly and increase the assembly speed.

In this embodiment, the lampshade 200 and the button 400 are integrally formed, which helps to simplify the manufacturing process and improve the manufacturing efficiency. Furthermore, the integral-forming design helps reduce the number of assemblies, improve assembly accuracy, reduce production costs, and reduce difficulty for manufacturing the products.

In this embodiment, the annular lamp assembly 100 further comprises: a plurality of separating ridges 510 arranged at intervals, and the separation ridges 510 are located between the inner annular wall 220 and the outer annular wall 210 for fixedly connecting the outer annular wall 210 and the inner annular wall 220.

The outer annular wall 210 and the inner annular wall 220 are connected through the separating ridges 510, thereby determining the relative distance between the outer annular wall 210 and the inner annular wall 220. In the process of forming the lampshade 200 by using an injection molding process, the positions in which the separating ridges 510 are located form a flow channel for a plastic material, and the plurality of the separating ridges 510 is arranged at intervals, which ensures that the plastic material has good fluidity, such that the injection molding process progresses faster and the injection molding quality is better.

In this embodiment, a single LED lamp bead 300 is located between two adjacent separating ridges 510, which helps to reduce the light blocking by the separating ridges 510.

In some embodiments, the circuit board 101 is a Printed Circuit Board (PCB).

In this embodiment, the circuit board 101 is provided with a plurality of first adhesive filling holes 610, wherein the first adhesive filling holes 610 are suitable for filling a space between two adjacent separating ridges 510 with an adhesive.

The annular lamp assembly 100 further comprises: a first adhesive for filling a space between two adjacent separating ridges 510.

Since the air in the environment where a smart toilet is used is generally humid, the first adhesive is used to fill the space between two adjacent separating ridges 510, and the first adhesive can isolate the LED lamp beads 300 from moisture, helping prolong the service life of the LIED lamp beads 300.

The first adhesive filling holes 610 are provided on the circuit board 101, wherein during the adhesive filling process, the liquid level of a liquid adhesive gradually rises from bottom to top, and when the liquid level rises to the separating ridges 510, the liquid adhesive spreads among the plurality of separating ridges 510, and wherein the liquid adhesive forms the first adhesive after cooling, which helps to improve the consistency of surfaces of the first adhesive among the different separating ridges 510 and ensures the flatness of the surfaces of the first adhesive. Furthermore, the first adhesive filling holes 610 are formed on the circuit board 101, which not only helps control the adhesive filling process but also simplifies the structural composition.

In this embodiment, the annular lamp assembly 100 further comprises: a plurality of connecting bars 520, wherein the connecting bars 520 connect the inner annular wall 220 and the button 400.

The button 400 and the inner annular wall 220 are connected through the connecting bars 520 to facilitate determining the relative distance between the button 400 and the inner annular wall 220.

In this embodiment, the connecting bar 520 comprises a first connecting section 521 and a second connecting section 522 perpendicular to each other, wherein the connecting bars 520 are arranged around the button 400 in a counterclockwise or clockwise direction.

Specifically, a corner θ is formed at the connection between the first connecting section 521 and the second connecting section 522, and the directions of openings of the corners θ are arranged around the button 400 in a counterclockwise or clockwise direction.

The length of the first connecting section 521 is shorter than that of the second connecting section 522, one end of the first connecting section 521 is connected to the button 400, and one end of the second connecting section 522 is connected to the inner side of the inner annular wall 220.

The structure of the connecting bars 520 facilitates the user to press the button 400 and ensures that the button 400 can move downward relative to the inner annular wall 220 under a small pressing force.

In this embodiment, the circuit board 101 is provided with a plurality of second adhesive filling holes 620, wherein the second adhesive filling holes 620 are suitable for filling a space formed by the enclosing of the inner annular wall 220 with an adhesive.

The annular lamp assembly 100 further comprises: a second adhesive for filling the space formed by the enclosing of the inner annular wall 220.

In this embodiment, the top surface of the second adhesive is lower than the bottom of the button 400, which ensures that the button 400 can be pressed normally.

In this embodiment, a locating piece 202 is provided on the outer side surface of the outer annular wall 210, wherein the locating piece 202 is provided with a threaded through hole 203 for disposing a screw to fix the lampshade 200 to the circuit board 101, thereby improving assembly accuracy.

In this embodiment, the number of the locating pieces 202 is two, wherein the two locating pieces 202 are arranged opposite to each other, and a connecting line of the two locating pieces 202 passes through the center of the lampshade 200.

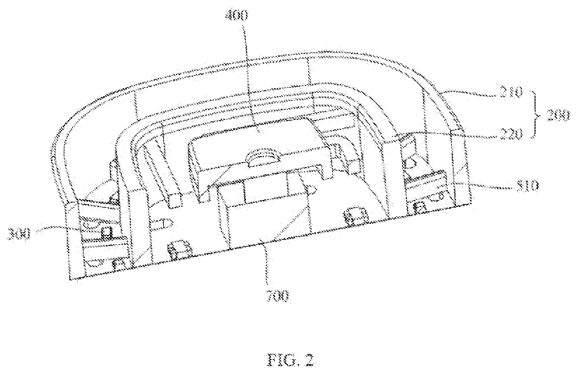

FIG. 2 is a longitudinal cross-sectional view of the annular lamp assembly 100 shown in FIG. 1. No circuit board is shown in FIG. 2.

Referring to FIG. 2, in this embodiment, a button switch 700 is provided in the circuit board 101 (refer to FIG. 1) below the button 400, wherein the button switch 700 is electrically connected to the LED lamp beads 300, and the button 400 is suitable for pressing the button switch 700 to turn the LED lamp beads 300 on or off.

The second adhesive can isolate the button switch 700 from moisture to prevent the button switch 700 from damage resulting from the impact by moisture in a humid environment, which helps to prolong the service life of the button switch 700.

In this embodiment, the annular lamp assembly 100 further comprises: a functional unit, wherein the button switch 700 is electrically connected to the functional unit, and the button 400 is also suitable for pressing the button switch 700 to turn the functional unit on or off, and wherein the LED lamp beads 300 are turned on when the functional unit is turned on, and the LED lamp beads 300 are turned off when the functional unit is turned off.

The LED lamp beads 300 are turned on and turned off synchronously with the functional unit to intuitively prompt the user for a usage state of a corresponding functional operation.

in summary, the annular lamp assembly 100 enables good compatibility between waterproofing and functional display requirements, meets the high-tech requirements of products, and can provide users with a better interactive experience.

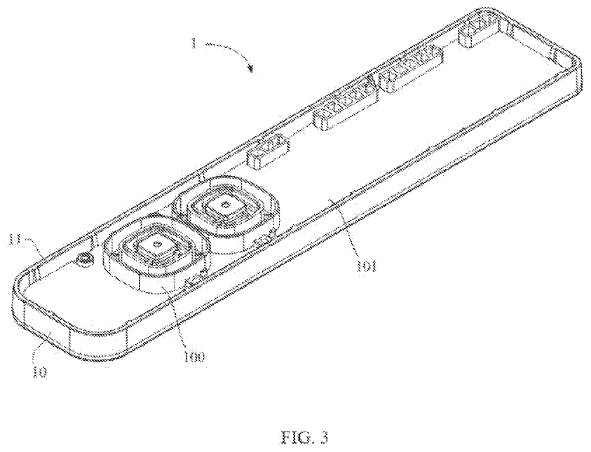

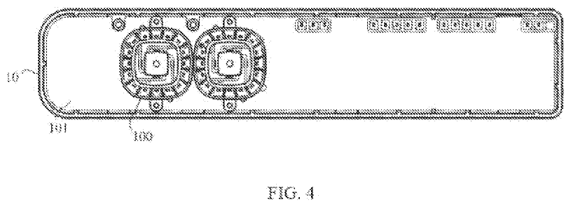

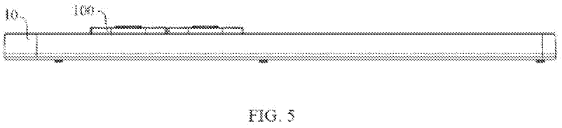

FIG. 3 is a perspective view of an operation box 1 according to an embodiment of the present invention. FIG. 4 is a top view of the operation box 1 shown in FIG. 3. FIG. 5 is a front view of the operation box 1 shown in FIG. 3.

Referring to FIGS. 3 to 5, the present invention further provides the operation box 1, comprising: a box body 10 and the annular lamp assembly 100, wherein the box body 10 has an opening 11 at the top, the annular lamp assembly 100 is located in the box body 10, and the opening 11 exposes the annular lamp assembly 100.

In this embodiment, the number of the annular lamp assemblies 100 in the box body 10 is two, which are used to prompt butt cleaning and female cleaning, respectively.

In this embodiment, the circuit board 101 is located in the box body 10 and is in contact with the bottom surface of the box body 10.

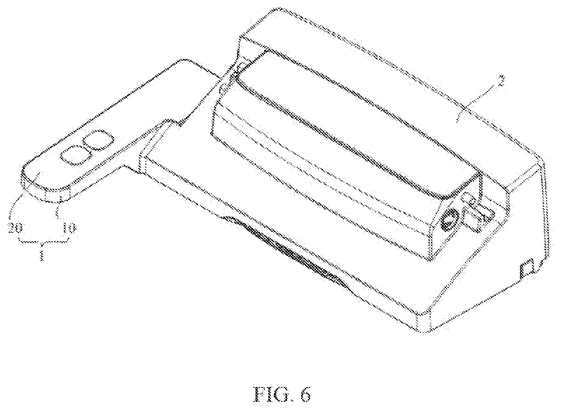

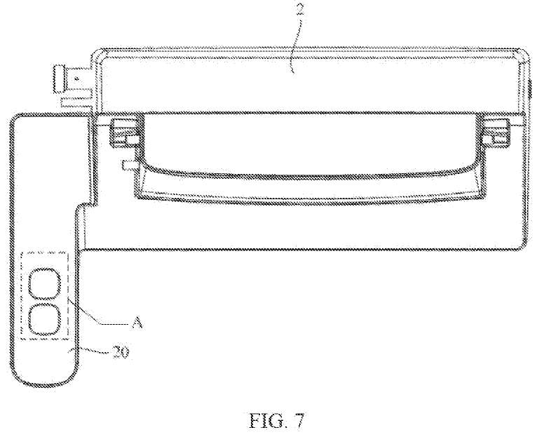

FIG. 6 is a perspective view of an operation box 1 and a mounting base 2 according to an embodiment of the present invention; and FIG. 7 is a top view of the operation box 1 and the mounting base 2 shown in FIG. 6.

Referring to FIGS. 6 and 7, in this embodiment, the operation box 1 is provided on one side of the mounting base 2.

In this embodiment, the operation box 1 further comprises: a surface sticker 20, wherein the surface sticker 20 is pasted on the opening 11 (refer to FIG. 3).

Patterns are printed on the surface sticker 20 for prompting the functions. The surface sticker 20 is pasted on the opening 11 (refer to FIG. 3), which facilitates a user to understand corresponding functional operations, facilitates the user to press the button 400 (refer to FIG. 1), and helps to make the operation box 1 to have a more beautiful appearance.

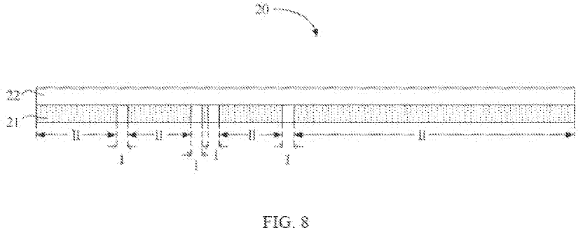

FIG. 8 is a longitudinal cross-sectional view of the surface sticker 20 according to an embodiment of the present invention.

Referring to FIG. 8, in this embodiment, the surface sticker 20 comprises: a light-shielding layer 21, wherein the light-shielding layer 21 comprising a light-transmitting area I and a light-shielding area II, the light-transmitting area I being annular, and the light-transmitting area I being aligned with the annular band area, and a surface sticker top layer 22, the surface sticker top layer 22 covering the top of the light-shielding layer 21, and light emitted from the LED lamp beads 300 being transmitted through the light-transmitting area I and the surface sticker top layer 22.

The light-shielding layer 21 helps to improve the light intensity contrast between the annular light and a surrounding area, thereby improving sensory stimulation to the user, and facilitating prompting the user to perform correct operations.

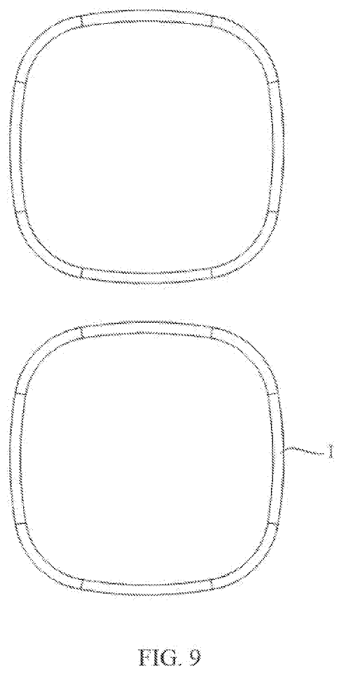

FIG. 9 is an enlarged view of an area A shown in FIG. 7.

Referring to FIG. 9, the light emitted from the LED lamp beads 300 forms an annular light that exits from the light-transmitting area I.

In this embodiment, the thickness value of the annular light formed by the light emitted from the LED lamp beads 300 is 0.75 mm.

Although the present invention is disclosed as above, the present invention is not limited thereto. Any of those skilled in the art can make various changes and modifications without departing from the spirit and scope of the present invention. Therefore, the protection scope of the present invention should be subject to the scope defined by the claims.

1. An annular lamp assembly, comprising:
a circuit board;
a lampshade comprising an outer annular wall and an inner annular wall separately provided on the circuit board, and an annular band area between the outer annular wall and the inner annular wall;
a plurality of LED lamp beads located on the circuit board and arranged at intervals along the annular band area; and
a button provided in a space formed by enclosing the inner annular wall, the button being suitable for turning the LED lamp beads on or off.

2. The annular lamp assembly of claim 1, wherein the LED lamp beads are arranged at equal intervals, and scattering regions of light emitted from the adjacent LED lamp beads partially overlap.

3. The annular lamp assembly of claim 1, further comprising a plurality of separating ridges positioned between the inner annular wall and the outer annular wall, wherein the separating ridges fixedly connect the outer annular wall and the inner annular wall, and are arranged at intervals.

4. The annular lamp assembly of claim 3, wherein a single LED lamp bead is located between two adjacent separating ridges.

5. The annular lamp assembly of claim 4, wherein the circuit board is provided with a plurality of first adhesive filling holes suitable for filling a space between two adjacent separating ridges with an adhesive.

6. The annular lamp assembly of claim 5, further comprising a first adhesive for filling the space between two adjacent separating ridges.

7. The annular lamp assembly of claim 1, further comprising a plurality of connecting bars connecting the inner annular wall and the button.

8. The annular lamp assembly of claim 7, wherein the connecting bars comprise a first connecting section and a second connecting section perpendicular to each other, wherein the connecting bars are arranged around the button in a counterclockwise or clockwise direction.

9. The annular lamp assembly of claim 1, wherein the lampshade and the button are integrally formed.

10. The annular lamp assembly of claim 1, wherein the circuit board is provided with a plurality of second adhesive filling holes suitable for filling a space formed by the enclosing of the inner annular wall with an adhesive.

11. The annular lamp assembly of claim 10, further comprising a second adhesive for filling the space formed by the enclosing of the inner annular wall.

12. The annular lamp assembly of claim 1, wherein a button switch is provided in the circuit board below the button, the button switch is electrically connected to the LED lamp beads, and the button is suitable for pressing the button switch to turn the LED lamp beads on or off.

13. The annular lamp assembly of claim 12, further comprising a functional unit, wherein the button switch is electrically connected to the functional unit, and the button is suitable for pressing the button switch to turn the functional unit on or off, and wherein the LED lamp beads are turned on when the functional unit is turned on, and the LED lamp beads are turned off when the functional unit is turned off.

14. An operation box, comprising:
a box body having an opening at a box body top; and
the annular lamp assembly of claim 1, wherein the annular lamp assembly is located in the box body, and the opening exposes the annular lamp assembly.

15. The operation box of claim 14, further comprising a surface sticker pasted on the opening.

16. The operation box of claim 15, wherein the surface sticker comprises:
a light-shielding layer comprising an annular light-transmitting area and a light-shielding area, wherein the light-transmitting area is aligned with the annular band area; and
a surface sticker top layer covering a top of the light-shielding layer, such that light emitted from the LED lamp beads is transmitted through the light-transmitting area and the surface sticker top layer.
